(19) United States
(12) Patent Application Publication
(10) Pub. No.: US 2002/0176558 A1
(43) Pub. Date: Nov. 28, 2002

(54) Modem and system with call waiting switching facilities and method of supporting customer access to a service provider

(76) Inventors: Christopher Tate, Bishops Stortford (GB); Michael F. Grant, Bishops Stortford (GB)

Correspondence Address: William M. Lee, Jr., LEE, MANN, SMITH, MCWILLIAMS,, SWEENEY & OHLSON, P.O. Box 2786, Chicago, IL, 60690-2786, US

(21) Appl. No.: 09/747,693

(22) Filed: Dec. 22, 2000

(51) Int. Cl. H04M 3/42

(52) U.S. Cl. 379/215.01; 379/208.01; 379/213.01

(57) ABSTRACT

A modem (34, 40) at a customer premises (14, 38) and a switch at an exchange (12, 50) are modified to allow a data session (102, 202) supported on a dedicated wireline communication resource (16) to be optionally terminated (110), but preferably suspended (114, 218), upon detection of a subsequently placed voice call (104, 204) on the dedicated wireline communication resource (16). Before termination of a data session, a user either selects a termination option or is provided with an in-call option to terminate the data session, with the voice call then switched (122) to the dedicated wireline communication resource (16). The data session is therefore cleared down rather than lost through connection corruption. Alternatively, the modem (34, 40) and the exchange (50) interact to silence modem transmissions therebetween, whilst retaining a data connection (20) between the exchange (12, 50) and an end-point data service provider (ISP, 18). Assuming acceptance (128, 228) of the voice call and its subsequent termination, the modem (34, 40) and the exchange (12, 50) again interact (134, 236) to re-establish (136, 238) the data session across the dedicated wireline communication resource (16). Re-training (138, 238) of modems involved in the data session is required, but suspension of a sector in an end-to-end physical link avoids re-dialing and any associated connection costs.

### BACKGROUND TO THE INVENTION

This invention relates, in general, to a wireline communication system that provides a shared communication resource, such as a copper pair, to a data terminal (via a modem) and at least one conventional telephone at a subscribers premises. More particularly, but not exclusively, the present invention relates to a system and modem that supports customer access, via a dedicated wireline link, to a data service provider (or the like) while ensuring that voice telephony capabilities, over the dedicated wireline link, remain visible to the customer.

### SUMMARY OF THE PRIOR ART

With an ever increasing demand for communication access and bandwidth, the telecommunication industry, in general, is constantly tasked with enhancing subscriber connectivity and improving service. With the provision of wideband communication resources (through the use of digital subscriber line techniques and fibre-to-the-home systems) to a subscriber premises still in its infancy. service providers are generally limited to adapting legacy (e.g. copper pair) Systems to accommodate improved services. For example, a change from analog wireline connection to an integrated services digital network (ISDN) yielded an increase in data rate achieved through the improved data transport mechanism of ISDN.

As will be appreciated, many households are served through a simple copper pair (or the like), with several subscriber units (in a single household) vying for bandwidth over this solitary copper pair connection. Subscriber units may include conventional telephones and computers, although more exotic species of devices are being developed that obtain access to remote data repositories or services via a suitably configured modem. In other words, many users/households have a single telephone line that is used for both telephony and voice band modem traffic (e.g. for Internet access).

Generally, there are two principal mechanisms by which multiple subscriber units can be connected to an exchange through a common wireline communication resource. First, a household (i.e. customer premises) can be provided with a main socket from which secondary sockets provide individual access to subscriber units. Alternatively, a central modem can provide isolation between a voice telephony sub-network and a data sub-network, with the modem providing an interface between the subscriber premises and the wireline communication resource to the exchange.

In a shared wireline communication resource scenario, if the customer/subscriber is using a modem, any incoming call is seen as engaged In view of the off-hook condition of the modem. However, a facility known as “Call Waiting ” is available which uses network information tones (NITs) to alert the user of another incoming call; call waiting is exchange-driven and merely looks for the off-hook condition. As regards actuation of this network service, a customer is able to turn the service on or off by simply dialing a predetermined activation string, such as *57, before a call. Similarly, deactivation of the call waiting feature typically requires another code to switch the feature off.

In terms of an on-going voice call, call waiting is effective and merely generates an audible alert that another call is pending. A user is then provided with an option to switch between incoming calls. Unfortunately, these alert tones used for alerting the user of a second incoming call often cause a conventional modem to drop the line. Consequently, voice telephony call waiting is generally considered incompatible if the customer/subscriber is currently in a data session that requires use of a modem to support data access through the wireline communication resource. Putting this in a slightly different way, signal tones used in the modem are corrupted by call waiting alert tones resulting in a data session being interrupted or dropped.

A modification of the basic call waiting concept has spawned “internet call waiting”. In internet call waiting, the customer/subscriber in a data session is able to accept voice telephony calls, provided that the customer/subscriber is at the data terminal. More specifically, during a data session, it is understood that internet call waiting causes an exchange to communicate an internet protocol (IP) message to the data terminal in the event that a voice telephony call is desired to be established across the common wireline communication resource to the customer premises. The IP message is interpreted, in session, by the data terminal and the IP message then causes the data terminal to indicate to its user the existence of the voice telephony call (typically through the use of a “pop-up” icon on a screen). Should the user wish to take the voice telephony call, then an uplink IP message to the exchange initiates the voice call whilst the data session is contemporaneously terminated through the release of the modem. The issue associated with internet call waiting is therefore directly concerned with whether the user is in a position to register the notification or flag identifying the existence of the voice call. Clearly, if the user is away from the screen (or equivalent man machine interface), the user will not register the flag. Moreover, even if the flag remains in place, any delay in the user responding to the flag may nevertheless cause the calling party to abandon the attempt to establish the voice call connection at that particular instance. In other words, the calling party simply gives up and goes on-hook when no answer is received from the dialed party within an arbitrarily selected time irrespective of the IP message being displayed at the data terminal. The internet call waiting mechanism is therefore considered to be limited in its application since successful operation is dependent upon the addressed party responding relatively quickly within an appropriate but arbitrarily selected time frame.

If a common wireline resource is utilised for both voice and data communications, the loading of the resource, if not now but in the future, will predominantly be data traffic. The dropping of the data connection (through the disruption of modem operation) to a desired data repository during an attempt to establish a voice telephony call is therefore undesirable from a user's perspective on at least two counts. First, the data connection cannot be easily re-established on an automatic basis and, second, the user is likely to have to pay for re-establishment of the data connection. More specifically, in the second respect, with most modem call-charging regimes, maintenance of the data connection is free, whereas system access and information download is subject to an appropriate service tariff. Consequently, an existing (and preferably permanent) data connection may not incur any expense for the user unless use is made of the link and information is communicated between the user and the exchange/data repository. Voice calls and existing call waiting facilities on a shared wireline communication resource may therefore present sub-optimum utilisation of the wireline resource from a user (i.e. customer's) perspective, with such voice calls presently requiring the user to re-establish the data connection.

In summary of the conventional approaches, a user would disable call waiting before using a voice band modem in order to prevent data communications being interrupted; this is inconvenient and requires manual intervention. An alternative solution would be to detect the call waiting tones, pick up the telephony call, and then immediately allow the modem call to be dropped. On completion of the telephony call, the user is forced a redial and then restrain the voice band modem, this requires a new call to be dialed with possibly a further connection charge. Systems which provide incoming call indication (e.g. internet call waiting) that use the IP link to provide a “popup” indication on the user's computer have the disadvantage of requiring the user to be located at the computer at the time of the pop-up notification.

### SUMMARY OF THE INVENTION

According to a first aspect of the present invention there is provided a communication system comprising a communication resource supporting an end-to-end data session between a first modem in a customer premises and a data service unit coupled thereto via an exchange, wherein the end-to-end data session is supported via a combination of the communication resource and a communication link between the exchange and a second modem associated with the data service unit, and wherein: the exchange has a controller configured to identify, during a data session, a presence of a request for establishment of a voice call to the customer premises from a third party voice telephony unit, the controller further arranged to support at least one of: generation of a control signal in response to the presence of the request and an ability to cause communication of the control signal to the first modem over the communication resource, the control signal arranged to cause the first modem to terminate the data session by going on-hook; and generation of at least one control signal in response to acceptance of the voice call, the controller capable of routing the at least one control signal to at least the first modem to cause temporary suspension of data traffic across the communication resource, thereby to at least initially support the end-to-end data session through maintenance of at least the second modem in an off-hook condition with respect to the communication link.

The controller is preferably arranged to identify termination of the voice call and to cause, in response thereto, generation of a second control signal over, for example, a dedicated narrowband wireline communication resource (such as a twisted-pair), the second control signal configured to instigate re-establishment of the end-to-end data connection.

The controller of the exchange is preferably arranged to record an indication of a connection path of the end-to-end data connection in response to the presence of the request for establishment of the voice call.

The controller may be arranged to support at least one of: generation and transmission of an auto re-establishment command to the first modem to cause the first modem to go off-hook as a precursor to the re-establishment of a second data session to the second modem; and generation and transmission of a modem re-training command to initiate re-training of the first modem and the second modem to re-establish the end-to-end data connection.

In another aspect of the present invention there is provided a method of providing voice and data services to customer premises serviced through a communication resource between the customer premises and a switch, the method comprising: establishing an end-to-end data connection from a data device in the customer premises to a data service unit coupled to the exchange, the end-to-end data connection supported by a first modem at the customer premises and a second modem associated with the data service unit and wherein the end-to-end data connection is via a combination of the communication resource and a communication link between the exchange and the data service unit, within a data session, at the exchange, identifying a presence of a request for establishment of a voice call to the customer premises; and at least one of: generating a control signal at the exchange in response to the presence of the request and communicating the control signal to the first modem over the communication resource, the control signal arranged to cause the first modem to terminate the data session by going on-hook; and at the exchange, in response to acceptance of the voice call, generating at least one control signal for communication to at least one of the first modem and the second modem to cause temporary suspension of data traffic across the communication resource, thereby to at least initially maintain the end-to-end data session through maintenance of at least the second modem in an off-hook condition.

The method may comprise identifying termination of the voice call and generating a second control signal over the communication resource, the second control signal configured to instigate re-establishment of the end-to-end data connection.

The method may further comprise, at the exchange, recording an indication of a connection path of the end-to-end data connection in response to the presence of the request for establishment of the voice call.

In a preferred embodiment, the method may further comprise at least one of: having the exchange transmit an auto re-establishment command to the first modem to cause the first modem to go off-hook; and initiating re-training of the first modem and the second modem to re-establish the end-to-end data connection.

In another aspect of the present invention there is provided a switch for an exchange that provides selective interconnection of a first modem to one of a voice telephony unit and a second modem associated with a data service provider, interconnection between the exchange and the first modem occurring, in use, across a communication resource and such that a data session can be established between the first modem and the second modem over a combination of the communication resource and a communication link and a voice call can be established across the communication resource to the voice telephony unit, the switch having a controller configured to identify, during a data session, a presence of a request for establishment of a voice call, the controller further arranged to support at least one of: generation of a control signal in response to the presence of the request and an ability to cause communication of the control signal to the first modem over the communication resource, the control signal arranged to cause the first modem to terminate the data session by going on-hook; and generation of at least one control signal in response to acceptance of the voice call, the controller capable of routing the at least one control signal to at least the first modem to cause temporary suspension of data traffic across the communication resource, thereby to at least initially support the end-to-end data session through maintenance of at least the second modem in an off-hook condition with respect to the communication link.

The communication link may be a virtual channel to preserve bandwidth on a network side during periods of maintaining the modem associated with the data service unit in an off-hook condition.

In the switch. the controller may be arranged to support at least one of: generation and transmission of an auto re-establishment command to the first modem to cause the first modem to go off-hook as a precursor to the re-establishment of a second data session to the second modem; and generation and transmission of a modem re-training command to initiate retraining of the first modem and the second modem to re-establish the end-to-end data connection.

In another aspect of the present invention there is provided a modem for coupling, in use, to a data terminal in a customer premises. the modem comprising a controller responsive to tonal commands on a communication resource, the modem operationally configured to perform at least one of: an on-hook function in response to a first tonal message indicating a presence of a request to establish a voice call over the communication resource, thereby to terminate an active data session, a data suspension function in response to a second tonal message in which a data session is temporarily suspended for the duration of a subsequently established voice call, the data suspension function inhibiting transmission of data over the communication resource during the subsequently established voice call.

The modem is preferably further operationally configured to perform re-establishment of an end-to-end data connection in response to a third tonal message.

Re-establishment of the end-to-end connection generally causes the modem to perform a re-training procedure and to resume use a communication path of a suspended data session. Alternatively, re-establishment of the end-to-end connection causes the modem to acquire a new data path for continuation of the data session in a new call.

In still yet another aspect of the present invention there is provided a computer program product for a controller within an exchange, the computer program product comprising: code that establishes an end-to-end data connection from a data device to a data service unit coupled to the exchanges the end-to-end data connection supported between a first modem associated with a customer premises and a second modem associated with the data service unit and wherein the end-to-end data connection is via a combination of a communication resource and a communication link between the exchange and the data service unit, code that identifies a presence of a request for establishment of a voice call to the customer premises during a data session; and at least one of; code that generates a control signal at the exchange in response to the presence of the request and communicates the control signal to the first modem over the communication resource, the control signal arranged to cause the first modem to terminate the data session by going on-hook; and code, active in response to acceptance of the voice call, that generates at least one control signal for communication to at least one of the first modem and the second modem to cause temporary suspension of data traffic across the communication resource, thereby to at least initially maintain the end-to-end data session through maintenance of at least the second modem in an off-hook condition; wherein the codes reside in a computer readable medium.

In a preferred embodiment, the computer program product may comprise: code that identifies termination of the voice call and that generates a second control signal over the communication resource the second control signal configured to instigate re-establishment of the end-to-end data connection.

In a preferred embodiment, the computer program product may comprise: code that causes recordal of an indication of a connection path of the end-to-end data connection in response to the presence of the request for establishment of the voice call.

In a preferred embodiment, the computer program product may comprise at least one of: code that causes the exchange to transmit an auto re-establishment command to the first modem to cause the first modem to go off-hook; and code that initiates re-training of the first modem and the second modem to re-establish the end-to-end data connection.

Another aspect of the invention provides a computer program product for a modem controller, the computer program product comprising: code that produces an on-hook condition in the modem to terminate an active data call, the code operational in response to detection of a first tonal message indicating a presence of a request to establish a voice call over a communication resource; code, responsive to a second tonal message, that causes temporary suspension of a data session for a duration of a subsequently established voice call, thereby preventing transmission of data over the communication resource during the subsequently established voice call, wherein the codes reside in a computer readable medium.

In this aspect, the computer program product may further comprise code operationally configured to perform re-establishment of an end-to-end data connection in response to a third tonal message.

In a preferred embodiment, the computer program product may comprise code that causes the modem to perform a re-training procedure and to resume use a communication path of a suspended data session.

In a preferred embodiment, the computer program product may comprise code that causes the modem to acquire a new data path for continuation of the data session in a new call.

In still yet a further aspect, a communication system is provided in which a modem coupled to a switch across a communication resource supporting an end-to-end data session between the modem and a data service unit coupled to the switch, the communication system comprising; means for generating an alert associated with a desire to establish a voice call with a voice telephony unit over the communication resource and through the modem; and at least one of: a) means for terminating the data session in response to the alert; and b) means for causing temporary suspension of data traffic across the communication resource in response to the alert and acceptance of the voice call whilst maintaining the end-to-end data session.

The communication system may include means to identify termination of the voice call and to cause, in response thereto, generation of a control signal over the communication resource, the control signal configured to instigate re-establishment of the end-to-end data session.

In one particular embodiment, the communication system has means to record an indication of a connection path of the end-to-end data connection in response to the presence of the request for establishment of the voice call.

In another alternative or complementary embodiment, the communication system comprises means to support at least one of: generation and transmission of an auto re-establishment command to the modem to cause the modem to go off-hook as a precursor to the re-establishment of a second data session to a second modem associated with the data service unit; and generation and transmission of a modem re-training command to initiate re-training of the modem and the second modem to re-establish the end-to-end data connection.

The communication system may further comprise means for selecting an operational default for the system, the operational default identifying whether a data session is capable of interruption by at least one of the alert and the voice call. Additionally, or alternatively, the system has means for generating and communicating a request to have the switch swap between a data session and the voice call.

In a further aspect of the invention there is provided a modem providing, in use, an interface to a customer premises, the modem comprising a controller responsive to tonal commands on a communication resource, such as a narrowband twisted-pair, and wherein the modem provides isolation between a telephony sub-net within the customer premises and a data sub-system, the controller operationally configured to perform: a data session suspension function operational in response to a tonal alert indicating existence of a desire to establish a voice call to the telephony sub-net during a data session, the data session suspension function arranged temporarily to inhibit data transmissions from at least the modem for the duration of a subsequently established voice call.

The controller, preferably, is further capable of generating and communicating a control message to an exchange coupled, in use, to the modem through the communication resource, the control message instructing the exchange to initiate swapping between the data session and the voice call.

The modem may include SLIC and ring circuitry to provide an audible alert to units coupled, in use, to the telephony sub-net.

The control message may further cause the exchange to suspend data transmission from a remote modem of a data service entity to the modem over the communication resource during the subsequently established voice call. and wherein the exchange is further caused to maintain, at least initially. the remote modem in an off-hook condition.

In still yet another aspect of the invention there is provided a method of operating a modem providing an interface between a telephony sub-net within a customer premises and a data sub-system of the customer premises, the method comprising: suspending a data session in response to a tonal alert, on a communication resource, indicating existence of a desire to establish a voice call to the telephony sub-net over the communication resource and during the data session; and maintaining at least a remote modem involved in the data session with the modem, in an off-hook condition.

The method can include generating and communicating a control message to an exchange coupled, in use, to the modem through the communication resource, the control message instructing the exchange to initiate swapping between the data session and the voice call.

The modem may independently cause a telephone unit, coupled to the telephony sub-net, to ring.

Furthermore, there is provided a computer program product for controlling a modem providing a narrowband line interface between a telephony sub-net within a customer premises and a data sub-system of the customer premises, the computer program product comprising: code that suspends a data session in response to a tonal alert, on the communication resource, indicating existence of a desire to establish a voice call to the telephony sub-net over the communication resource and during the data session; and code that maintains at least a remote modem, involved in the data session with the modem, in an off-hook condition; wherein the codes reside in a computer readable medium.

The computer program product, in one embodiment, further comprises code that generates and communicates a control message to an exchange coupled, in use. to the modem through the communication resource the control message instructing the exchange to initiate swapping between the data session and the voice call.

In a preferred embodiment, the computer program product may comprise code that initiates modem re-training at termination of the voice call and in advance of re-establishment of the data session.

In a preferred embodiment, the computer program product may comprise code that allows a user to select an operational default identifying whether a data session is capable of interruption.

In another aspect, a communication system has a communication resource, such as a narrowband twisted-pair, supporting a narrowband voice call and a data session to customer premises equipment containing a telephony sub-net and a data sub-system, the communication system comprising: a modem in the customer premises equipment. the modem providing a line interface to the communication resource and wherein the modem provides a data session suspension function operational in response to a tonal alert on a communication resource, the tonal alert indicating existence of a desire to establish a voice call to the telephony sub-net over the communication resource and during a data session currently in progress on the communication resource, and wherein the modem is arranged to maintain at least a remote modem. involved in the data session with the modem, in an off-hook condition.

In still yet a further aspect, a tonal signal is modulated onto a communication resource, such as a narrowband twisted-pair, the tonal signal containing a succession of control tones arranged to cause a modem to: suspend a data session over the communication resource between the modem and a switch that selectively interconnects the modem to one of a data service unit and a voice telephony unit, the data session suspended in favour of a voice call, and re-train at termination of the voice call.

The various preferred features, as will become apparent, can be integrated with one another or implemented independently.

With the desire to maintain access to data repositories and the like. the inability of existing systems to maintain a continuous data link through a modem is addressed in by the various embodiments of the present invention.

The present invention advantageously provides a system in which a user can maintain a data connection whilst simultaneously taking a voice telephony call notified to the user within the data session. From a customer premises perspective, the present invention enhances the likelihood of a user being made aware of the existence of a voice call when the user is in a data session. Beneficially, the present invention provides increased operational flexibility by allowing the user to actively select (in a data session) or pre-select suspension of a data session in favour of a voice telephony call. The present invention is particularly valuable in “an always on” environment where a user would be permanently connected to the internet or corporate LAN via the subscriber line, since the present invention generally avoids a necessity re-connection and any associated fiscal costs.

The robust solutions offered by the various embodiments of the present invention differ from internet call waiting procedures that relies on a message being sent to a user's computer via the IP data link to alert them of an incoming telephone call. More particularly, the present invention has the advantage that it works whether or not the computer is attended.

By employing the concepts of the present invention. an end subscriber is advantageously able to join one of the “free internet calling plans” offered by service providers, and can log-on all day if the end user so desires without stopping any incoming calls A switch operator is further able to benefit (from a commercial perspective) since the switch operator can offer a service supporting the concepts of the present invention an a tariffed service.

Implementation of the present invention is compatible with existing wireline communication networks. and implementation costs may be restricted to either the exchange equipment or a customer's modem. Any change in modem functionality can, however, be meet substantially through the use of modified software code

### BRIEF DESCRIPTION OF THE DRAWINGS

Exemplary embodiments of the present invention will now be described with reference to the accompanying drawings, in which:

FIG. 1 is a schematic diagram of a first network configuration that has been adapted to support the concepts of a first embodiment of the present invention;

FIG. 2 is a schematic diagram of a second network configuration that has been adapted to support the concepts of a second embodiment of the present invention,

FIG. 3 is a flow diagram showing a preferred operating mechanism according to an embodiment of the present invention; and

FIG. 4 is a flow diagram showing another operating mechanism according to an alternative embodiment of the present invention.

### DETAILED DESCRIPTION OF A PREFERRED EMBODIMENT

Referring first to FIG. 1, there is shown a schematic diagram of a first network configuration 10 that has been adapted to support the concepts of a first embodiment of the present invention. In this first network configuration 10, an exchange 12 is coupled to individual customer premises 14 (only one of which is shown) through a dedicated wireline communication resource 16. The exchange 12 is further coupled to a data repository (such as an internet service provider, ISP, or the like) 18 through a suitable communication link 20. The exchange 12 acts to provide an interface to supplementary networks (not shown) and standard voice telephones (e.g. voice caller 22) in order to support end-to-end voice connections. Generally. the exchange 12 includes a suitable controller/control intelligence 23 that implements control logic for routing purposes and operational control of the exchange. the controller is invariably coupled to a memory device 24 that stores software algorithms or programs and call related data.

As regards the customer premises 14, a master socket 25 provides an interface to the dedicated wireline communication resource 16. Additional (secondary) sockets 26-28 provide spurs to telecommunications equipment. such as telephones 30-32 and a modem 34 that serves, for example, a personal computer 36. In this configuration, there is no isolation that can be provided between the various pieces of telecommunications equipment and an off-hook condition on the dedicated wireline communication resource 16.

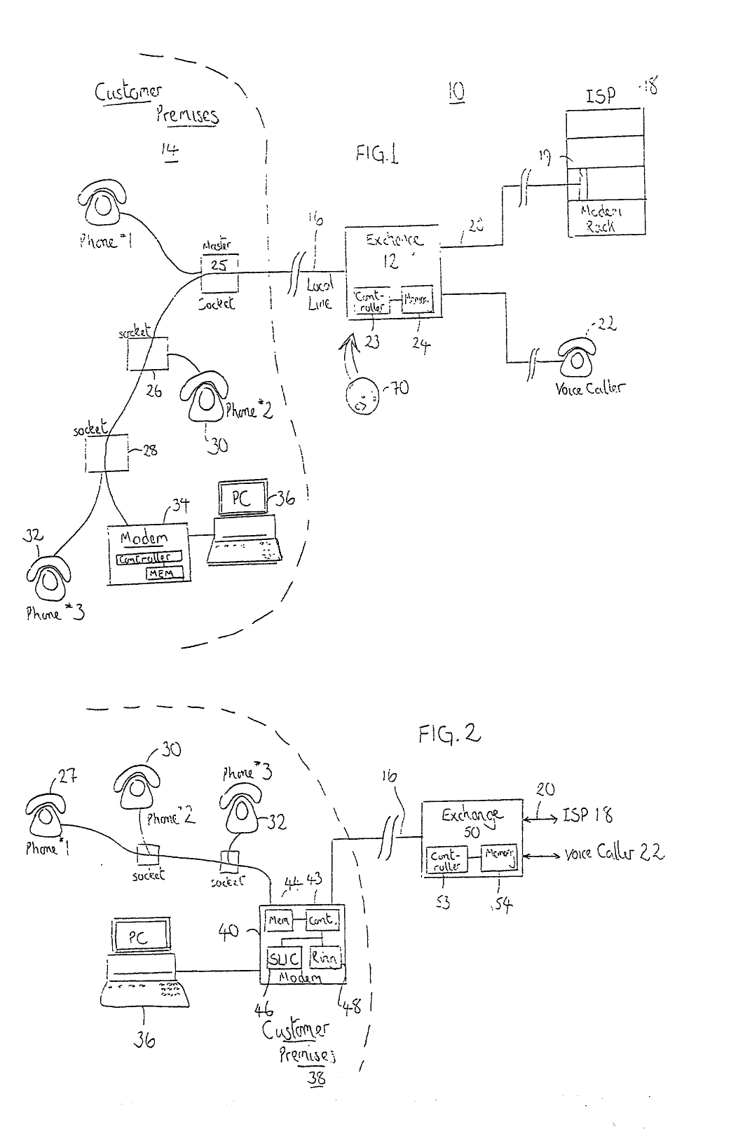

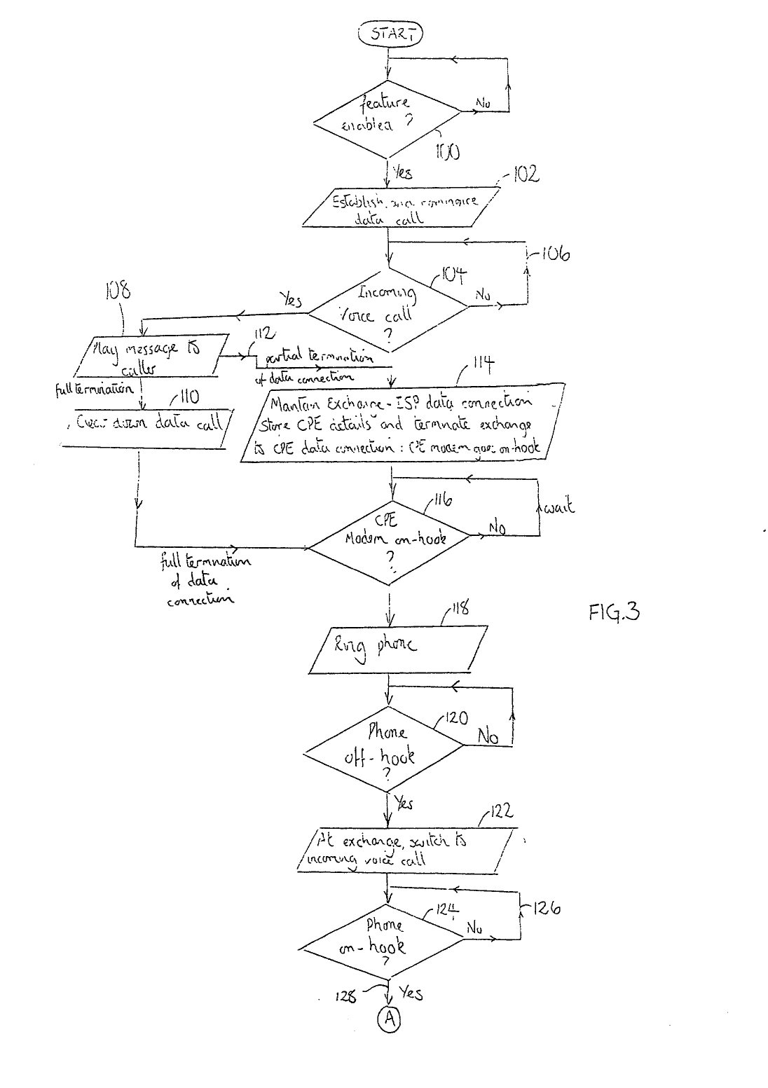

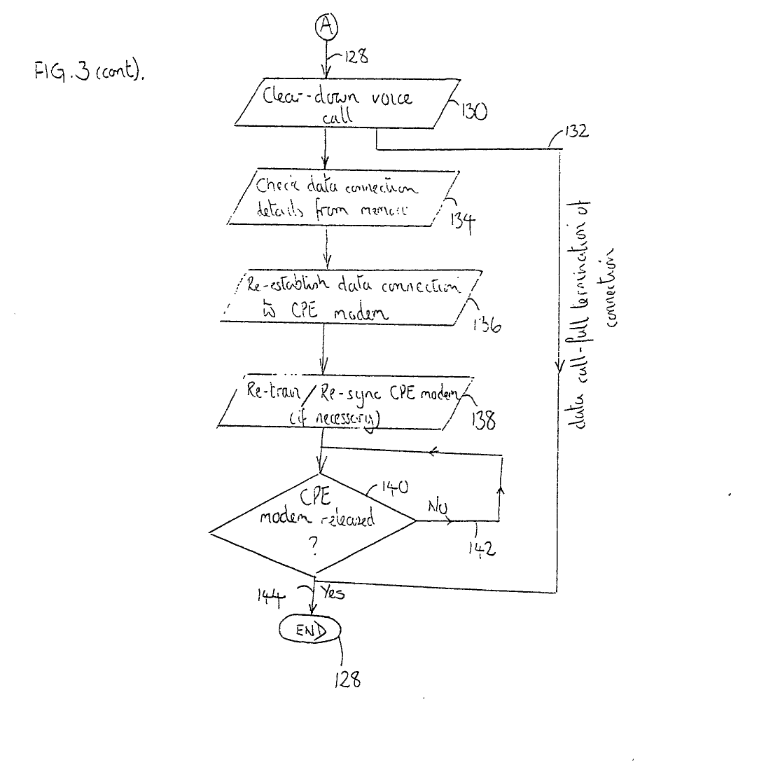

With respect to FIG. 2, a configuration of a customer premises wiring scheme 38 provides isolation between data and voice devices. In this alternative configuration, a modem 40 provides an interface to the dedicated wireline communication resource 16, with the modem 40 controlling access to a data terminal, such as a personal computer 36, or voice telephony equipment (principally telephones 27, 30 and 32). Again, the modem 40 includes a controller 43 and associated memory 44 that co-operate to support modem functionality and device inter-operation that will be subsequently discussed. In a particular embodiment, the modem 40 may also include a standard line interface card (SLIC) 46 and a ring circuit 48. The operation, structure and purpose of SLIC 46 and ring circuit 48 are well known in the art. An exchange 50 of the preferred architecture of FIG. 2 also includes a controller 53 and associated memory 54.

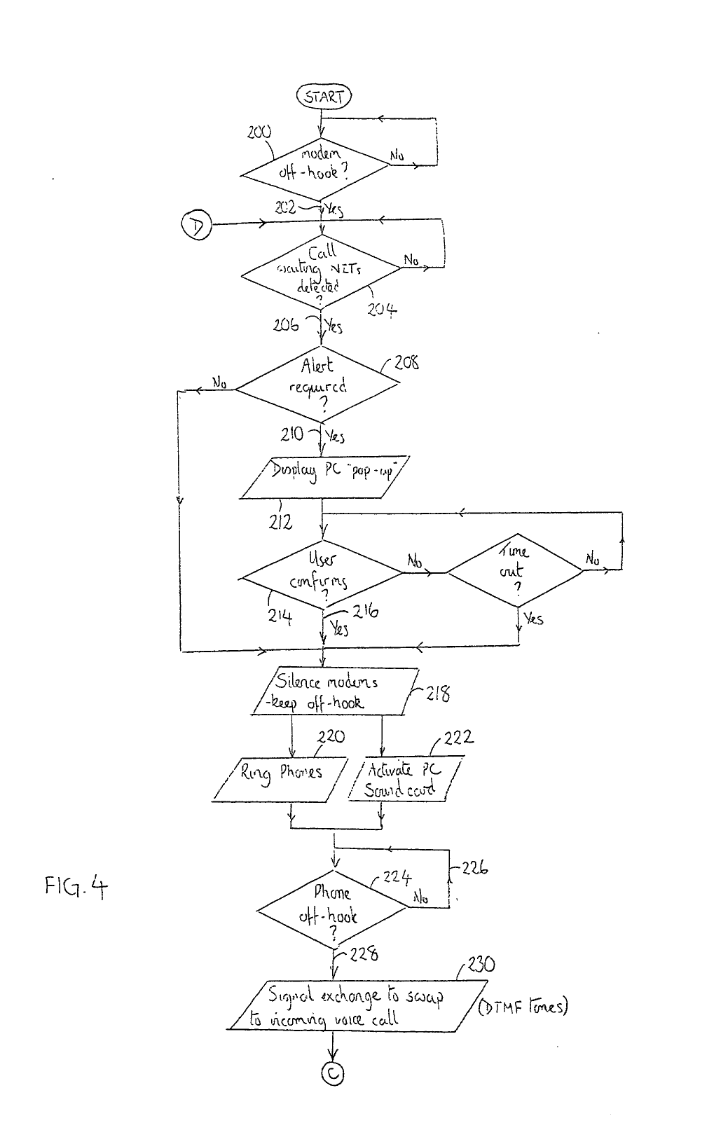

An understanding of the operating methodology of a first embodiment of the present invention can be obtained having regard to FIG. 3. The first embodiment of the present invention is supported through the exchange 12 (of FIG. 1) and more especially through the use of modified code that controls and administers connections a particular customer over a dedicated wireline communication resource. In this first embodiment, the customer is provided with an ability to select 100 or de-select the voice call interruption feature of the invention. Selection of the voice call interruption feature can be instigated through a suitable request, such as by entering a number string on a telephone handset. Provided that the feature is enabled, the process is best understood in the context of an existing data call 102 to an ISP or the like. The process therefore essentially begins in-call with the modem 34 at the customer premises 14 off-hook and a voice call (originating from voice caller 22) wishing to be connected to an addressed phone at the customer promises 14. Until such time as a voice call request is identified 104 at the exchange, the data call is unaffected and monitoring for a voice call request is therefore ongoing 106. At realisation by the exchange 12 of the existence of a voice call request, the exchange 12 is preferably tasked to play 108 a short comfort message to the calling party indicating that voice call establishment to the called party is in the process of being set up, e.g. “We are trying to connect you—please wait”.

As regards the data call, there are two options, namely the complete end-to-end termination of the data call connection between the customer premises 14 and the ISP 18 or the partial tear down of the data call connection across the dedicated wireline communication resource between the exchange 12 and the customer premises 14 only. With full data call connection tear-down, the exchange instructs 110 the modem 34 in the customer premises 14 to release the dedicated wireline communication resource by going on-hook. With partial data call connection termination 112, the exchange 12 (and specifically control intelligence therein realized by the controller 23) again instructs the modem 34 in the customer premises to go on-hook, but the data connection between the exchange and the ISP is maintained and details of the customer address and routing path are stored 114 to enable subsequent automatic re-establishment of the end-to-end data connection. Of course, to force the CPE modem on-hook, the exchange could operate to block data transmissions from the modem in the ISP. In terms of partial data call connection termination (i.e. partial suspension of the connection), intelligence within the exchange is configured to intercept any specific release signaling tones from the modem at the customer premises, thereby preventing the total tear-down of a data connection path to an assigned modem 19 in the ISP 18.

As regards the information that the exchange can acquire and store. such information may include default instructions on whether a particular subscriber wishes to be interrupted when active in a data session or the telephone numbers associated with voice calls that must be accepted. The type of data connection that is established may be relevant, as is the actual usage of recovered data, e.g. random web browsing as opposed financial information. When the data connection is effectively suspended over a portion of the end-to-end communication path, the intelligence in the exchange stores at least the path to the modem in the ISP, the address of the modem in the subscriber premises involved in the data session and an association across a switch matrix to perfect end-to-end connectivity. Of course, other information, such as negotiated bandwidth, may also be stored.

The exchange is able to identify a type of call through a number of mechanisms. For example, the exchange can be aware of a data service provider through reference to a look-up table of stored addresses. Alternatively, the exchange could analyse the signal in a connection and then to distinguish between voice and data on the basis of a signature envelope. Thirdly, the exchange could be informed by a direct mechanism, such as use of DTMF tone or the like.

From a practical standpoint, lack of traffic between the ISP and exchange should not result in the connection being dropped, subject to their being no time-out provisions associated with inactivity of the ISP modem. Furthermore, with the use of a virtual connection (such as supported by an asynchronous transmission mode architecture) between the exchange 12 and the modem 19 in the ISP 18, then potential loss of bandwidth is minimized.

Having passed the instruction to the modem 34 to go on-hook, the exchange monitors 116 the dedicated wireline resource 16 for the on-hook condition. Once the on-hook condition is sensed, such as through a change in line impedance (and as will be understood), the exchange can actuate ringing 118 of the phone in the customer premises 14 by applying the requisite line voltage. The modem in the subscriber premises is now configured to ignore the call alert, i.e. the modem is set to remain on-hook and not to auto-answer. The line is monitored 120 by the exchange for the off-hook condition whereafter the exchange can switch in 122 the voice call. The exchange then instigates monitoring 124 for the on-hook condition. So long as the voice call is on-going 126, monitoring for the on-hook condition continues, whereas a sensed on-hook condition 128 causes the exchange to clear-down 130 the voice call and then either attempt to re-establish the data connection to the customer's modem 34 or else to remain in a standby state 132 awaiting set-up of a new call on the dedicated wireline communication resource.

As regards auto re-establishment of the data connection, the exchange (12 of FIG. 1) operates to retain the data connection (which may be a virtual connection) to a modem in the ISP or the like. With the voice call having finished, the controller 23 interrogates 134 its associated memory 24 to recover data connection details. Using such details, the controller 23 re-establishes 136 the end-to-end data connection over the wireline communication resource 16, which end-to-end connection generally requires the re-training/re-synchronisation 138 of at least the modem 34 in the customer premises 14. The CPE modem (and especially its control logic) is then able to continue 140-142 with the data connection indefinitely, subject to no catastrophic data link failure or until such a time when the data call is released 144 by the subscriber.

The modem 34 at the customer premises is therefore tasked with either re-training or re-dialing, subject to the data connection release procedure adopted. In summary, the preferred embodiment detects call waiting tones and allows switching to telephony operation whilst preventing the line from being dropped by the modem. After the telephony call is completed the modem re-trains and continues without a new call being placed.

According to a preferred embodiment, the setting up of data call suspension process of the present invention can be implemented in a similar fashion to existing network services provider. More specifically, a customer therefore dials a predetermined sequence before making a call to an ISP 18, which sequence programmes the switch (in the exchange 12) to terminate/suspend the current data call as soon as there is an incoming voice call. For simplicity, the dial sequence could be programmed into the modem dial-up sequence, and so would be automatic as far as the end user is concerned. Of course, if the user is making an important internet call, e.g. booking a holiday, the sequence could optionally be omitted. In fact, in a preferred embodiment, a data terminal is configured to display two dial-up-connection icons, one labeled and supporting “Internet plus phone” and the other labeled and supporting “Internet Only—No Interruptions”.

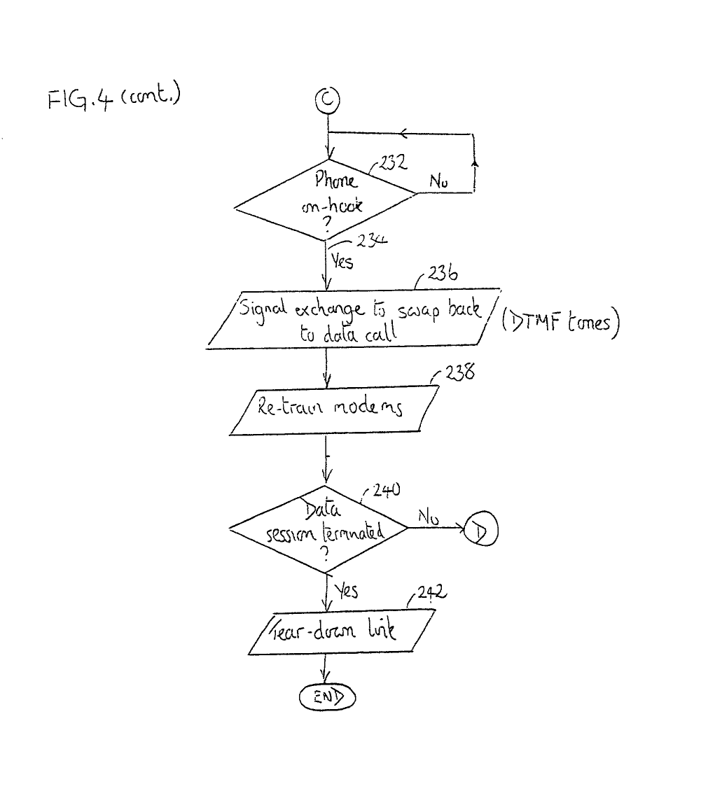

Clearly, the modification of the control logic in the exchange and particularly the switch provides a system that is entirely backwardly compatible with existing, i.e. deployed, modems. Indeed, the financial cost of implementing the change at the exchange 12 is relatively minor. However, in a further embodiment of the present invention, it is equally acceptable to provide a modified modem architecture that provides a point of isolation to a customer premises; this is reflected in FIG. 2 and the accompanying flow diagram of FIG. 4.

In the alternative embodiment of the present invention, operational control of the line in with the customer premises equipment (as opposed to the exchange used to support the first embodiment). Consequently, the modem 40 (of FIG. 2) has increased control logic and operational intelligence to supports the methodology described below. Assuming that the customer is initially in a data session (i.e. that the modem is off-hook 200-202), then the controller 43 monitors 204 the wireline communication resource for network information tones (NITs) indicative of the presence of a secondary call, namely the voice call. Upon detection 206 of NITs, the controller 43 preferably (but optionally) operates to determine 208 whether the user has requested that an alert be issued before the voice call is accepted. In the affirmative 210, the modem interacts with the interconnected computer 36 (involved in the data session) to cause the computer to display 212 an appropriate “pop-up” alert. The pop-up alert could be accompanied by or substituted by an audible alert from a sound card within the computer 36. As a design option, the system of a preferred embodiment requires the user to confirm 214-216 their intention to receive the voice call, which confirmatory action may be subject to a time-out function that either defaults in accepting the voice call (as shown in FIG. 4) or defaults to maintain the date session and therefore to reject the voice call.

Assuming that the voice call is to be accepted 216, then the controller 43 operates to silence 218 at least the local modem function at the customer premises but preferably also the remote modem function within the network. The controller 43 is, however, configured to maintain the modems off-hook and therefore to preserve the end-to-end data path.

With the system of FIG. 2 capable of providing isolation between a data call to the computer and voice telephony equipment (namely phones 27, 30 and 32 of FIG. 2), there are two alternative or complementary ways to proceed. If the modem includes SLIC 46 and ring circuitry 48 that provides the requisite line driving voltage to cause ringing at a telephone. then any internal phones within the customer premises can be rung 220. However, if the modem 40 is pared down in its functionality and circuitry to reduce cost then the alert to the user that announces the presence of the voice call is restricted to an alert 222 through the computer 38. As will be appreciated, the alert 222 from the computer can be visual, but is at least audible so as to mitigate any absence of the user from the vicinity of the computer's visual display unit.

The isolation provided by the preferred structural configuration of FIG. 2, as will be appreciated, allows the ringing of phones irrespective of whether the network connection (through the dedicated wireline communication resource 16) is off-hook, although this is achieved at size and expense of the modem 40 installed at the customer premises 38.

The controller 43 then monitors 224 the internal connection within the customer premises 38 to identify if 226 and when 228 a telephone handset goes off-hook. The off-hook condition of the telephone handset is typically adjudged on a change in line impedance or the like, as will be readily understood by the skilled addressee. Clearly, although not explicitly shown in the diagram, should the alert not be answered after a predetermined timeout then the controller is arranged to re-establish the data connection. Re-establishment of the data session generally requires appropriate notification to the exchange that the voice call has been rejected and the re-training/re-synchronization of the modems involved in the data call.

Assuming that at least one telephone 27, 30, 32 goes off-hook in an appropriate time period, then the controller 43 generates an acceptance signal that is communicated to the exchange 50 (of FIG. 2). the acceptance signal preferably takes the form of DTMF tones that are interpreted by the controller in the exchange to invoke instigation of a swap 230 from the existing data session to the voice call. The voice call can now be supported over the dedicated wireline communication resource 16, with the voice call switched into the dedicated wireline communication resource 16 and the ISP connection temporarily switched-out. The actual physical switch could multiplex paths, although it is desirable to ensure isolation between the voice path and the data path to the ISP 18 on a network side of any connection. If switching to the voice call is implemented with complete isolation of the data path to the assigned modem in the ISP. then the controller 53 in the exchange 50 temporarily stores the switching route to the modem in the ISP.

The controller 43 of the modem 40 at the customer promises 38 now passes the voice call to the telephone involved in the voice call, with the controller 43 further arranged to monitor 232 for an on-hook condition 234 that is indicative of termination of the voice call. With the voice call finished, the controller 43 can again signal 236 to the exchange 50 (preferably using DTMF tones) that the dedicated connection can be reverted to data traffic. There may, at this point, be some handshaking between the exchange 50 and the controller 43 of the modem 40 to confirm an operational understanding, although retraining 238 (and re-synchronization) of the modems involved in the data session may simply follow after a predetermined period. Re-connection of the end-to-end data path causes the switching out of the voice circuit required to support the voice call, and the re-connection of the ISP; this is achieved, as necessary, in the exchange 50 through appropriate control intelligence interaction with previously stored data pertaining to the data connection path. It should be appreciated that the ISP connection (via communication link 20) remain off-hook during the voice call, albeit that any assigned ISP modem is dormant with respect to data traffic to the customer premises 28 over dedicated wireline communication resource 16.

In the event that the data session is terminated 240 (for whatever reason, including user choice or link failure), then the end-to-end data connection is torn down 242. In the event that the link is severed other than my way of user choice, then the present invention also contemplates the use of a local macro (run in the controller of the modem) to re-establish the data connection: this auto re-establishment is, of course entirely optional.

In summary of the alternative embodiment of the present invention, control logic (associated with a preferably implemented in a CPE modem product) provides an ability to detect an operator's call waiting tone alert. Such an alert activates a procedure that firstly stalls (i.e. silences) the modem without causing dropping of the wireline communication resource. Thereafter, the control logic preferably causes ringing of telephone or telephones connected to the modem, although there is at least some audible or visual alert. If the external caller abandons the voice call before it is answered, then the re-training of the modem occurs. Alternatively, if the incoming call is answered, the appropriate “Call Waiting” call selection is made and the call taken in the normal way. On completion of the call the call selection is reverted and the modem signaled to re-train in order to continue data communications. It should be noted that the ISP modem should not drop the call when the subscriber modem is silenced but it should wait for a re-train sequence. In generality, the system of this embodiment of the present invention requires both hardware and software to implement the modified modem behaviour and any necessary telephone switching functions.

The system of the alternative embodiment of the present invention can clearly be adapted according to a user-selected operational set-up. For example, the user may define the time-out defaults. Furthermore, the level of information communicated to the user during the NITs (or subsequently) can identify a calling party's number, with such information correlated with pre-stored data that indicates whether a data session is to be suspended in favour of the voice call.

In generality, retraining of a modem typically includes such tasks as: i) the establishment of modem/line characteristics, ii) synchronization; iii) bit rate negotiation; etc.

Alternative embodiments of the invention may be implemented as computer program code encoded on a computer program product for use with a computer system. It is expected that such a computer program product may be distributed as a removable medium with accompanying printed or electronic documentation (e.g. shrink-wrapped software), preloaded with a computer system or distributed from a server or electronic bulletin board over a network (e.g. the Internet or World Wide Web). A series of computer instructions can therefore either be fixed on a tangible medium or fixed in a computer data signal embodied in a carrier wave that is transmittable to a computer system using wireline or wireless transmission techniques. The removable (i.e. tangible) medium may be a computer readable media, such as a diskette, CD-ROM, DVD-ROM or RAM, fixed disk, magneto-optical disks, ROMs flash memory or magnetic or optical cards. The series of computer instructions embodies all or part of the functionality previously described herein with respect to the system.

Software embodiments are represented in FIG. 1 by a CD-ROM 70, the CD-ROM being shown as loadable into the exchange 12. Of course, in software based embodiments, requisite code may be required to be downloaded into multiple physical entities, including the exchange and the modem associated with the customer premises.

Software embodiments of the invention may be implemented in any conventional computer programming language. for example, preferred embodiments may be implemented in a procedural programming language (e.g. “C”) or an object oriented programming language (e.g. “C++”).

Although the preferred operating method is realised by general or specific-purpose processor or logic circuits programmed with suitable machine-executable instructions, hardware components may possibly be used to implement certain features of the present invention. Of course, the present invention may be performed by a combination of hardware and software.

It will, of course, be appreciated that the above description has been given by way of example only and that modifications in detail may be made within the scope of the present invention. For example, while the preferred embodiment has been described in the context of a narrowband wireline system in which data and voice calls share the same bandwidth on a mutually exclusive basis, the underlying principles of the present invention can be applied to other communication resources of different systems, e.g. fixed wireless access (FWA) architectures.

We claim:

1. A communication system comprising a communication resource supporting an end-to-end data session between a first modem in a customer premises and a data service unit coupled thereto via an exchange, wherein the end-to-end data session is supported via a combination of the communication resource and a communication link between the exchange and a second modem associated with the data service unit, and wherein:
the exchange has a controller configured to identify, during a data session, a presence of a request for establishment of a voice call to the customer premises from a third party voice telephony unit, the controller further arranged to support at least one of:
generation of a control signal in response to the presence of the request and an ability to cause communication of the control signal to the first modem over the communication resource, the control signal arranged to cause the first modem to terminate the data session by going on-hook; and
generation of at least one control signal in response to acceptance of the voice call, the controller capable of routing the at least one control signal to at least the first modem to cause temporary suspension of data traffic across the communication resources thereby to at least initially support the end-to-end data session through maintenance of at least the second modem in an off-hook condition with respect to the communication link.

2. The communication system according to claim 1, wherein the controller is arranged to identify termination of the voice call and to cause, in response thereto, generation of a second control signal over the dedicated communication resource, the second control signal configured to instigate re-establishment of the end-to-end data connection.

3. The communication system according to claim 2, wherein the communication link is a virtual channel.

4. The communication system according to claim 1, wherein the controller of the exchange is arranged to record an indication of a connection path of the end-to-end data connection in response to the presence of the request for establishment of the voice call.

5. The communication system according to claim 4, wherein the controller of the exchange is arranged to support at least one of:
generation and transmission of an auto re-establishment command to the first modem to cause the first modem to go off-hook as a precursor to the re-establishment of a second data session to the second modem; and
generation and transmission of a modem re-training command to initiate retraining of the first modem and the second modem to re-establish the end-to-end data connection.

6. A method of providing voice and data services to customer premises serviced through a communication resource between the customer premises and a switch, the method comprising:
establishing an end-to-end data connection from a data device in the customer premises to a data service unit coupled to the exchange. the end-to-end data connection supported by a first modem at the customer premises and a second modem associated with the data service unit and wherein the end-to-end data connection is via a combination of the communication resource and a communication link between the exchange and the data service unit,
within a data session, at the exchange, identifying a presence of a request for establishment of a voice call to the customer premises; and at least one of:
generating a control signal at the exchange in response to the presence of the request and communicating the control signal to the first modem over the communication resource, the control signal arranged to cause the first modem to terminate the data session by going on-hook; and
at the exchange, in response to acceptance of the voice call, generating at least one control signal for communication to at least one of the first modem and the second modem to cause temporary suspension of data traffic across the communication resource, thereby to at least initially maintain the end-to-end data session through maintenance of at least the second modem in an off-hook condition.

7. The method in accordance with claim 6, further comprising:
identifying termination of the voice call and generating a second control signal over the communication resource, the second control signal configured to instigate re-establishment of the end-to-end data connection.

8. The method in accordance with claim 7, further comprising, at the exchange, recording an indication of a connection path of the end-to-end data connection in response to the presence of the request for establishment of the voice call.

9. The method in accordance with claim 6, further comprising at least one of:
having the exchange transmit an auto re-establishment command to the first modem to cause the first modem to go off-hook; and
initiating re-training of the first modem and the second modem to re-establish the end-to-end data connection.

10. A switch for an exchange that provides selective interconnection of a first modem to one of a voice telephony unit and a second modem associated with a data service provider, interconnection between the exchange and the first modem occurring, in use, across a communication resource and such that a data session can be established between the first modem and the second modem over a combination of the resource and a communication link and a voice call can be established across the communication resource to the voice telephony unit, the switch having a controller configured to identify, during a data session, a presence of a request for establishment of a voice call, the controller further arranged to support at least one of:
generation of a control signal in response to the presence of the request and an ability to cause communication of the control signal to the first modem over the communication resource, the control signal arranged to cause the first modem to terminate the data session by going on-hook; and
generation of at least one control signal in response to acceptance of the voice call, the controller capable of routing the at least one control signal to at least the first modem to cause temporary suspension of data traffic across the communication resource, thereby to at least initially support the end-to-end data session through maintenance of at least the second modem in an off-hook condition with respect to the communication link.

11. The switch according to claim 10, wherein the controller is arranged to identify termination of the voice call and to cause, in response thereto, generation of a second control signal over the communication resource, the second control signal configured to instigate re-establishment of an end-to-end data connection between the first modem and the second modem.

12. The switch according to claim 10, wherein the communication link is a virtual channel.

13. The switch according to claim 10, wherein the controller is arranged to record an indication of a connection path of an end-to-end data connection in response to the presence of the request for establishment of the voice call.

14. The switch according to claim 13 wherein the controller is arranged to support at least one of:
generation and transmission of an auto re-establishment command to the first modem to cause the first modem to go off-hook as a precursor to the re-establishment of a second data session to the second modem; and
generation and transmission of a modem re-training command to initiate re-training of the first modem and the second modem to re-establish the end-to-end data connection.

15. A modem for coupling, in use, to a data terminal in a customer premises, the modem comprising a controller responsive to tonal commands on a communication resource, the modem operationally configured to perform at least one of:
an on-hook function in response to a first tonal message indicating a presence of a request to establish a voice call over the communication resource, thereby to terminate an active data session;
a data suspension function in response to a second tonal message in which a data session is temporarily suspended for the duration of a subsequently established voice call, the data suspension function inhibiting transmission of data over the communication resource during the subsequently established voice call.

16. The modem of claim 15, further operationally configured to perform re-establishment of an end-to-end data connection in response to a third tonal message.

17. The modem of claim 16, wherein re-establishment of the end-to-end connection causes the modem to perform a re-training procedure and to resume use a communication path of a suspended data session.

18. The modem of claim 16, wherein re-establishment of the end-to-end connection causes the modem to acquire a new data path for continuation of the data session in a new call.

19. The modem of claim 1 5, wherein the communication resource is a dedicated narrowband wireline resource, and preferably a twisted pair.

20. A computer program product for a controller within an exchange. the computer program product comprising:
code that establishes an end-to-end data connection from a data device to a data service unit coupled to the exchange, the end-to-end data connection supported between a first modem associated with a customer premises and a second modem associated with the data service unit and wherein the end-to-end data connection is via a combination of a communication resource and a communication link between the exchange and the data service unit;
code that identifies a presence of a request for establishment of a voice call to the customer premises during a data session, and at least one of:
code that generates a control signal at the exchange in response to the presence of the request and communicates the control signal to the first modem over the communication resource, the control signal arranged to cause the first modem to terminate the data session by going on-hook; and
code, active in response to acceptance of the voice call, that generates at least one control signal for communication to at least one of the first modem and the second modem to cause temporary suspension of data traffic across the communication resource, thereby to at least initially maintain the end-to-end data session through maintenance of at least the second modem in an off-hook condition;
wherein the codes reside in a computer readable medium.

21. A computer program product for a modem controller, the computer program product comprising:
code that produces an on-hook condition in the modem to terminate an active data call, the code operational in response to detection of a first tonal message indicating a presence of a request to establish a voice call over a communication resource;
code, responsive to a second tonal message, that causes temporary suspension of a data session for a duration of a subsequently established voice call, thereby preventing transmission of data over the communication resource during the subsequently established voice call;
wherein the codes reside in a computer readable medium.

22. A communication system comprising a modem coupled to a switch across a communication resource supporting an end-to-end data session between the modem and a data service unit coupled to the switch, comprising:
means for generating an alert associated with a desire to establish a voice call with the voice telephony unit over the communication resource and through the modem; and at least one of:
a) means for terminating the data session in response to the alert; and
b) means for causing temporary suspension of data traffic across the communication resource in response to the alert and acceptance of the voice call whilst maintaining the end-to-end data session.

23. The communication system of claim 22, further comprising:
means to identify termination of the voice call and to cause, in response thereto, generation of a control signal over the communication resource, the control signal configured to instigate re-establishment of the end-to-end data session.

24. The communication system of claim 23, further comprising means to record an indication of a connection path of the end-to-end data connection in response to the presence of the request for establishment of the voice call.

25. The communication system of claim 24, further comprising means to support at least one of:
generation and transmission of an auto re-establishment command to the modem to cause the modem to go off-hook as a precursor to the re-establishment of a second data session to a second modem associated with the data service unit, and
generation and transmission of a modem restraining command to initiate re-training of the modem and the second modem to to-establish the end-to-end data connection.

26. The communication system of claim 22. further comprising means to generate a sensorial alert during a data session to indicate the presence of the alert associated with the desire to establish the voice call.

27. the communication system of claim 26, wherein the sensorial alert is at least one of an audible alert and a visual alerts.

28. The communication system of claim 22, further comprising means for selecting an operational default for the system, the operational default identifying whether a data session is capable of interruption by at least one of the alert and the voice call.

29. The communication system of claim 22, further comprising means for generating and communicating a request to have the switch swap between a data session and the voice call.

30. A modem providing, in use, an interface to a customer premises, the modem comprising a controller responsive to tonal commands on a narrowband communication resource and wherein the modem provides isolation between a telephony sub-met within the customer premises and a data sub-system, the controller operationally configured to perform:
a data session suspension function operational in response to a tonal alert indicating existence of a desire to establish a voice call to the telephony sub-net during a data session, the data session suspension function arranged temporarily to inhibit data transmissions from at least the modem for the duration of a subsequently established voice call.

31. The modem of claim 30, the controller further capable of generating and communicating a control message to an exchange coupled, in use, to the modem through the narrowband communication resource, the control message instructing the exchange to initiate swapping between the data session and the voice call.

32. The modem of claim 31, further having SLIC and ring circuitry to provide an audible alert to units coupled, in use, to the telephony sub-net.

33. The modem of claim 31, wherein the tonal alert is realised by network information tones and the modem includes a detector arranged to detect the network information tones.

34. The modem of claim 31, wherein the control message further causes the exchange to suspend data transmission from a remote modem of a data service entity to the modem over the narrowband communication resource during the subsequently established voice call, and wherein the exchange is further caused to maintain, at least initially, the remote modem in an off-hook condition.

35. The modem of claim 31, wherein the modem is arranged to initiate re-training at termination of the voice call and in advance of re-establishment of the data session.

36. The modem of claim 31, wherein the modem is coupled, in use, to a data unit and the controller further includes a data unit driver arranged to cause the data unit to generate a sensorial alert during a data session to indicate the desire to establish the voice call.

37. The modem of claim 36, wherein the sensorial alert is at least one of an audible alert and a visual alert.

38. The modem of claim 30, wherein the controller is arranged to select an operational default identifying whether a data session is capable of interruption by at least one of the alert and the voice call.

39. A method of operating a modem providing an interface between a telephony sub-net within a customer premises and a data sub-system of the customer premises, the method comprising:
suspending a data session in response to a tonal alert, on a communication resource, indicating existence of a desire to establish a voice call to the telephony sub-net over the communication resource and during the data session; and
maintaining at least a remote modem, involved in the data session with the modem, in an off-hook condition.

40. the method of claim 39, further comprising:
generating and communicating a control message to an exchange coupled. in use, to the modem through the communication resource, the control message instructing the exchange to initiate swapping between the data session and the voice call.

41. The method of claim 39, further comprising having the modem independently cause a telephone unit. coupled to the telephony sub-net, to ring.

42. The method of claim 40, further comprising initiating modem re-training at termination of the voice call and in advance of re-establishment of the data.

43. The method of claim 42, having a user select an operational default identifying whether a data session is capable of interruption.

44. A computer program product for controlling a modem providing a narrowband line interface between a telephony sub-net within a customer premises and a data sub-system of the customer premises, the computer program product comprising:
code that suspends a data session in response to a tonal alert, on the communication resource, indicating existence of a desire to establish a voice call to the telephony sub-net over the communication resource and during the data session; and
code that maintains at least a remote modem, involved in the data session with the modem, in an off-hook condition;
wherein the codes reside in a computer readable medium.

45. A communication system having a communication resource supporting a narrowband voice call and a data session to customer premises equipment containing a telephony sub-net and a data sub-system, the communication system comprising:
a modem in the customer premises equipment, the modem providing a line interface to the communication resource and wherein the modem provides a data session suspension function operational in response to a tonal alert on a communication resource, the tonal alert indicating existence of a desire to establish a voice call to the telephony sub-net over the communication resource and during a data session currently in progress on the communication resource, and wherein the modem is arranged to maintain at least a remote modem, involved in the data session with the modem, in an off-hook condition.

46. A tonal signal modulated onto a communication resource, the tonal signal containing a succession of control tones arranged to cause a modem to:
suspend a data session over the communication resource between the modem and a switch that selectively interconnects the modem to one of a data service unit and a voice telephony unit, the data session suspended in favour of a voice call;
re-train at termination of the voice call.

47. The tonal signal of claim 46, wherein the communication resource is a narrowband wireline communication resource, and preferably a twisted-pair.
